(19) United States
(12) Patent Application Publication
(10) Pub. No.: US 2009/0276712 A1
(43) Pub. Date: Nov. 5, 2009

(54) Safety awareness system

(75) Inventors: Brandon Glenn Gregory, Lillington, NC (US); Jonathon A. Taylor, Peoria, IL (US); Kevin Allen Crass, West Bend, WI (US); Jesse Austin Griggs, Waverly, IA (US); Steve Marmon, Stanford, CA (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: CATERPILLAR INC., Peoria, IL (US)

(21) Appl. No.: 12/112,416

(22) Filed: Apr. 30, 2008

(51) Int. Cl. G06F 3/00

(52) U.S. Cl. 715/733

(57) ABSTRACT

The disclosure describes, in one aspect, a method of providing notification data. A user can input notification data at a terminal in response to one or more prompts. The notification data is transmitted from the terminal to a centralized server. The centralized server stores the notification data. The centralized server may be polled to obtain the notification data stored by the centralized server. Finally, notification display systems display a visual indication of the notification data.

### TECHNICAL FIELD

This patent disclosure relates generally to notification broadcasting methods and systems and, more particularly to a safety awareness system and method to manage notification information and dynamically convey notification information.

### BACKGROUND

Public and private entities regularly distribute notification information to various groups of people, such as employees, customers, and other individuals. For example, a government agency may wish to distribute notification information to people in a particular location, such as an airport. A company may wish to distribute information to its employees at one or more company locations. Various methods are used to convey notification information. For example, loudspeakers may be used to audibly broadcast notification information throughout a building or geographic location. Likewise, a memorandum or an electronic message may be sent to all employees. However, these systems for conveying notification information may be disruptive. For example, loudspeakers used to audibly broadcast certain types of notification information may be disruptive to employees attempting to concentrate on other work matters. In some emergency situations when it is desirable to disrupt the work activates of employees, such as a fire, loudspeakers used to audibly broadcast notification information are appropriate.

Distributing electronic messages to employees, although not audible, may nonetheless be disruptive to those employees that receive the message. Additionally, many employees may not have access to electronic messages. For example, in a manufacturing facility employees may not receive electronic messages on a regular basis due to work constraints. Likewise, an area itself may be inaccessible electronic messages, such as an airport. In such situations, it is difficult to distribute notification information without causing undue interruption.

Companies may further seek to distribute notification information pertaining to workplace safety. Many companies track and organize information related to workplace incidents, such as accidents resulting in worker injuries. For example, U.S. Pat. No. 6,065,000 to Jensen describes a system for tracking workplace incidents. However, the disclosed system does not provide an adequate notification function as the system does not provide real-time information to alert employees of the status of workplace incidents. Without a system for notifying employees of workplace incidents, it is often difficult to modify employee behavior to improve safety. Therefore, the system disclosed by Jensen does not achieve an improvement in workplace safety through the use of an appropriate notification system.

The foregoing background discussion is intended solely to aid the reader. It is not intended to limit the disclosure, and thus should not be taken to indicate that any particular element of a prior system is unsuitable for use within the disclosed system, nor is it intended to indicate that any element, including solving the motivating problem, is essential in implementing the innovations described herein. The implementations and application of the innovations described herein are defined by the appended claims.

### SUMMARY

The disclosure describes, in one aspect, a method of providing notification data in a computing network including a client terminal, a centralized server and one or more notification data display systems. A user can input notification data through an interface disposed at the client terminal. Specifically, the user inputs notification data in response to one or more prompts or visual cues provided by the interface. The notification data is transmitted from the client terminal to the centralized server via the computing network. The centralized server provides a data store with respect to the notification data. The centralized server may be polled by one or more notification display systems to which are disposed to identify themselves on the computing network and to obtain the notification data stored by the centralized server. Finally, the one or more notification display systems display a visual indication of the notification data.

In another aspect, a computer-readable medium having computer executable instructions provides identification by a notification display system and polling by the notification display system to present a visual representation of notification data in a computing network. The computing network includes a client terminal disposed to obtain input of notification data in response to one or more visual prompts or cues. The client terminal is further disposed to transmit the notification data to the centralized server where the notification data is stored. The computer executable instructions include instructions for performing identifying the notification display system to the centralized server and instructions for polling the centralized server to obtain the notification data stored by the centralized server. Finally the computer executable instructions include instructions for displaying a visual indication of the notification data on at least one notification display system.

In yet another aspect, a notification broadcasting system for distributing notification data to distinct locations within a network is provided. The notification broadcasting system includes at least one terminal capable of accepting notification data from a user and transmitting the notification data to a server connected to the network. At least two notification display systems connect to the network and are capable of polling the server to obtain the notification data. Each of the notification display systems comprises a summary display system and a detailed display system. Further, each of the notification display systems displays summary notification data on the summary display system and detailed notification data on the detailed display system in response to notification data being transmitted to the notification display system in response to the notification display system polling the server through the network.

### BRIEF DESCRIPTION OF THE DRAWING(S)

FIG. 1A illustrates a side view of an exemplary notification display system;

FIG. 1B illustrates a front view of the exemplary notification display system shown in FIG. 1A;

FIG. 2 illustrates a block diagram of an exemplary notification display system;

FIG. 3 illustrates an exemplary notification reporting system in accordance with one embodiment of the disclosure;

FIG. 4 illustrates an exemplary notification summary report in accordance with one embodiment of the disclosure.

### DETAILED DESCRIPTION

This disclosure relates to methods and systems for providing notification data to individuals and groups. The described technique includes inputting notification data at a terminal in response to one or more prompts from the terminal. Next the notification data is transmitted from the terminal to a centralized server and stored by the centralized server. The centralized server is polled to obtain the notification data. Finally, the notification data is displayed on a notification display system.

A notification broadcasting system distributes notification data to distinct locations within a network. The system includes at least one terminal capable of accepting notification data from a user and transmitting the notification data to a server connected to the network. At least two notification display systems are connected to the network and capable of polling the server to obtain the notification data. Each of the notification display systems has a summary display system and a detailed display system. The notification display systems display summary a coarse indication on the summary display system and detailed notification data on the detailed display system in response to notification data being transmitted to the notification display system after the notification display systems polls the server.

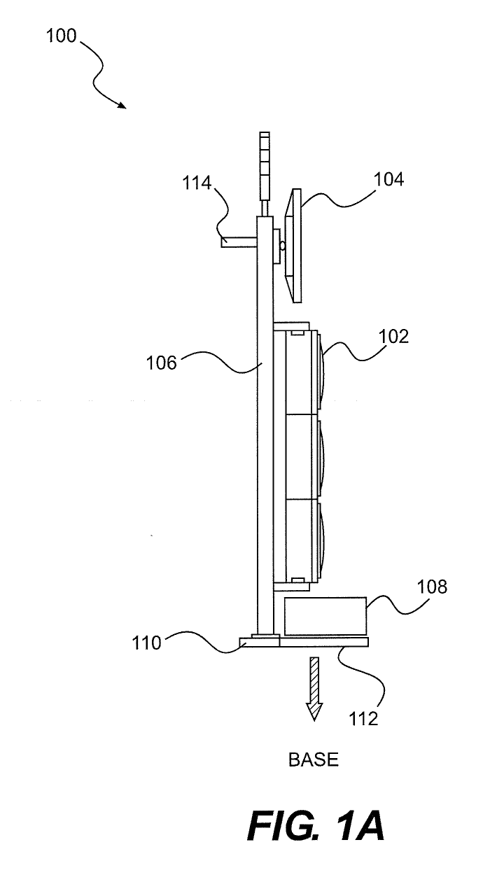

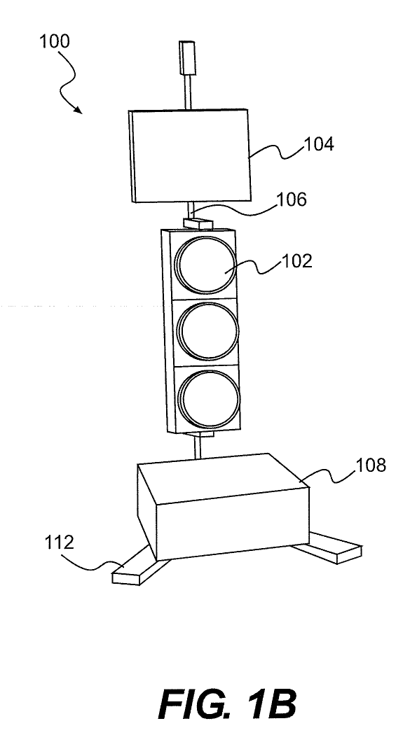

Turning now to the figures, FIG. 1A illustrates a side view of an exemplary notification display system. The notification display system 100 includes a summary display system 102 and a detailed display system 104. The summary display system 102 and detailed display system 104 may be mounted to a frame 106 which provides a suitable height and location to mount the summary display system 102 and a detailed display system 104 so that individuals can readily observe any information displayed on the summary display system 102 and a detailed display system 104. A controller 108 manages the summary display system 102 and a detailed display system 104. Additionally, the controller may provide network access to additional controllers and computing resources connected to the network.

In one embodiment, the notification display systems allow for module installation and movement. Wheels 110 attached to a base 112 allow the notification display system 100 to be easily moved from one location to another. Additionally, a handle 114 may aid in the movement of the notification display system 100. For example, the notification display system 100 may be set up in a manufacturing facility to alert workers to worker accidents and other safety related information. During the morning hours the notification display system 100 may be located near the entrance to the facility so that workers can easily see the device as they arrive for work. Later in the day the notification display system 100 may be moved to a cafeteria area so that works may observe the device as they eat lunch. Additionally, multiple notification display systems may provide more complete notification coverage throughout a large space, such as a manufacturing facility, office building or airport.

Turing to FIG. 1B, a front view of the exemplary notification display system 100 is shown. The summary display system 102 and the detailed display system 104 are illustrated attached to the frame. In one embodiment, the summary display system 102 is a stacklight. Stacklights are commonly used to control vehicular traffic flow and are readily recognizable to many individuals. Use of a stacklight allows individuals to quickly obtain relevant summary information regarding events. For example, in a workplace environment, the summary display system 102 may be configured to display information regarding workplace accidents. The summary display system 102 may be a stacklight display have a red light, a yellow light and a green light. In such a configuration, the green light may indicate no recent accidents. The yellow light may indicate a recent, but not serious, accident or injury. Finally, the red light may indicate a recent serious accident or injury.

In some embodiments, the detailed display system 104 is a liquid crystal display (LCD). LCDs are thin display devices that uses relatively small amounts of electricity. Therefore, LCDs work well in applications were portability is a factor and the display is on for a majority of any given day. In some embodiments, the LCD is a standard computer monitor using standard computer connections, such as Video Graphics Array (VGA) or Digital Visual Interface (DVI). The detailed display system 104 displays detailed information regarding notifications. For example, in a workplace environment, the detailed display system 104 may be configured to display information regarding workplace accidents. Information may include a textual description of a recent accident, photos of the proper use of equipment or video demonstrating proper use of equipment. Some embodiments include audio speakers that can be used to play audio with a video or make live or prerecorded announcements.

The summary display system 102 and detailed display system 104 both connect to the frame 106. Additionally, the frame 106 connects to the controller 108 and the wheels 110. The controller 108 can communicate with the summary display system 102 and detailed display system 104 in a number of ways. For example, cables can be routed from the controller 108 to the summary display system 102 and detailed display system 104 through the frame 106. Additionally, wires may be routed external to the frame 106. In another embodiment the controller 108 communicates with the summary display system 102 and detailed display system 104 wirelessly.

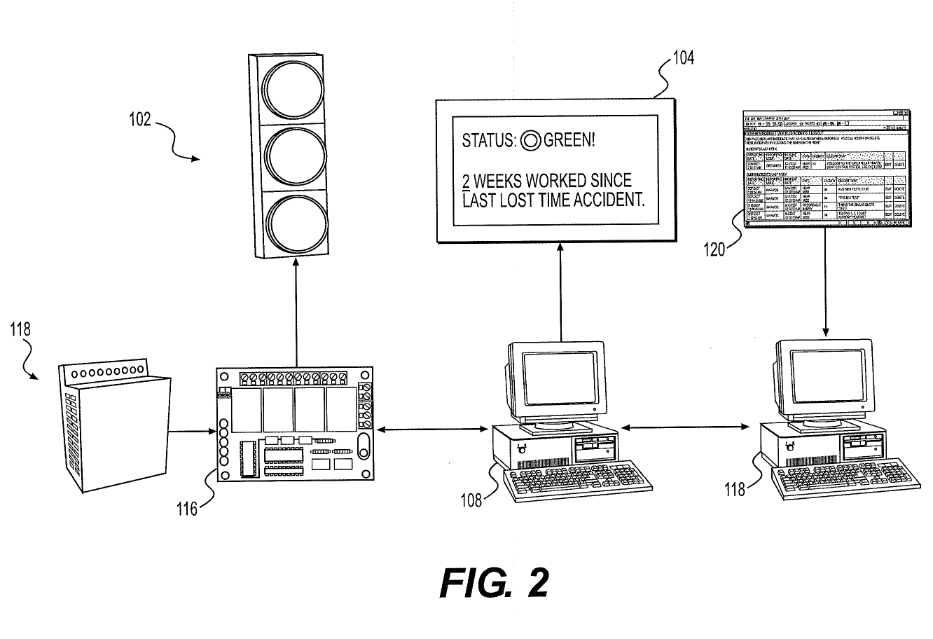

FIG. 2 illustrates a block diagram of an exemplary notification display system shown in FIG. 1A and FIG. 1B. The summary display system 102 is illustrated as a stacklight, but can be any display capable of quickly relying summary information to individuals. The summary display system 102 or stacklight interfaces with the controller 108 through any suitable interface. In one embodiment, the stacklight or summary display system 102 interfaces with the controller 108 using an interface card 116. In the illustrated example, interface card 116 uses Electronic Industries Alliance (EIA) standard RS-232. However, other appropriate standard and propriety interfaces may be used.

In the illustrated embodiment, power supply 117 provides electrical power for the notification display system 100. In one embodiment, power supply 117 converts 125 volt alternating current to 12 volt direct current. The 12 volt direct current powers the notification display system 100 components such as the summary display system 102, detailed display system 104, controller 108, and interface card 116. Alternatively, there may be multiple power supply 117 units. For example, the controller 108 and detailed display system 104 may each have their own power supply 117 units.

In one embodiment, the controller 108 interfaces with a centralized server 118 using standard networking protocols. For example, the controller 108 may interface with the centralized server 118 using Ethernet based on the Institute of Electrical and Electronics Engineers (IEEE) 802.3 specification. Alternatively, the controller 108 may interface with the centralized server 118 using wireless local area networks such as Wi-Fi based on the IEEE 802.11 specification. Other standard and proprietary networking protocols may be used to connect the controller 108 and centralized server 118.

A terminal 120 connects to the centralized server 118. An operator at the terminal 120 enters notification data in response to one or more prompts by the terminal 120. After inputting the notification data at the terminal 120, the terminal 120 transmits the notification data to the centralized server 118. After transmitting the notification data to the centralized server 118, the centralized server 118 stores the notification data. Storing the notification data makes it available to the notification display system 100. In one embodiment, the controller 108 may obtain the notification data by polling the centralized server 118. Therefore, the centralized server 118 does not need to maintain a list of network addresses for all notification display systems 100. Rather, the centralized server 118 simply serves data to the notification display systems 100 in response to being polled. Finally, after polling the centralized server 118 to obtain the notification data stored by the centralized server 118, the notification display system 100 displays a visual indication of the notification data on at least one notification display system. Displaying the notification data on the summary display system 102 or detailed display system 104 allows individuals to observe any notification data.

The notification data may include any information that may be useful to individuals. In a workplace environment, notification data may include information relating to workplace accidents. For example, accident notification data may be displayed. The accident notification data may include details relating to the last workplace accident and the amount of time since the last lost time accident. Additionally, the notification data may include audio or video messages. In order to display complex messages, the controller 108 may be a standard computing device.

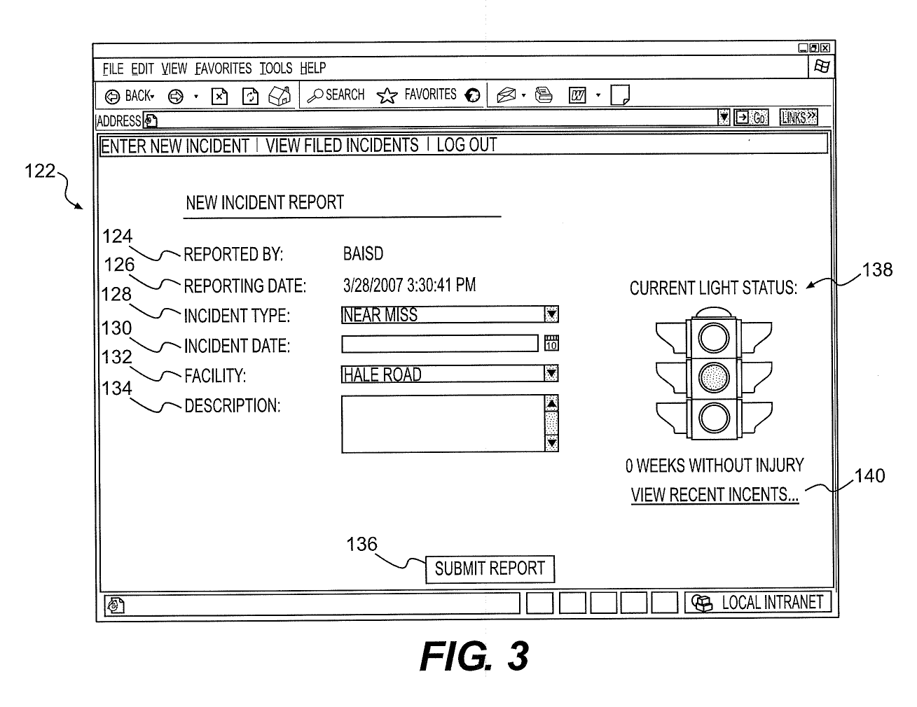

Turing to FIG. 3, a program for entering notification data on the terminal 120 is shown. In the illustrated embodiment, an operator uses a webpage to enter the notification data on the terminal 120 concerning workplace accidents. An incident report page 122 is used to enter the data. In this embodiment, the incident report page 122 automatically records reported by 124 information using operator log on information for the terminal 120 or incident report page 122. Similarly, the reporting date 126 is automatically recorded by the incident report page 122. The incident report page 122 prompts the operator for the incident type 128. The incident type 128 can include, for example, whether there was an accident or a near miss. The incident date 130 prompts the operator for the date of the incident they are recording. The facility 132 prompts the operator for the location of the incident. For example, if a company has multiple locations, the facility 132 prompts the operator for which location the incident occurred at. The description field 134 prompts the user for a full description of the incident. Finally, the operator may submit the report by clicking the submit report button 136. A current status display 138 shows the current state of the notification display system 100. Finally, a recent incidents link 140 can be selected and recent incidents will be displayed.

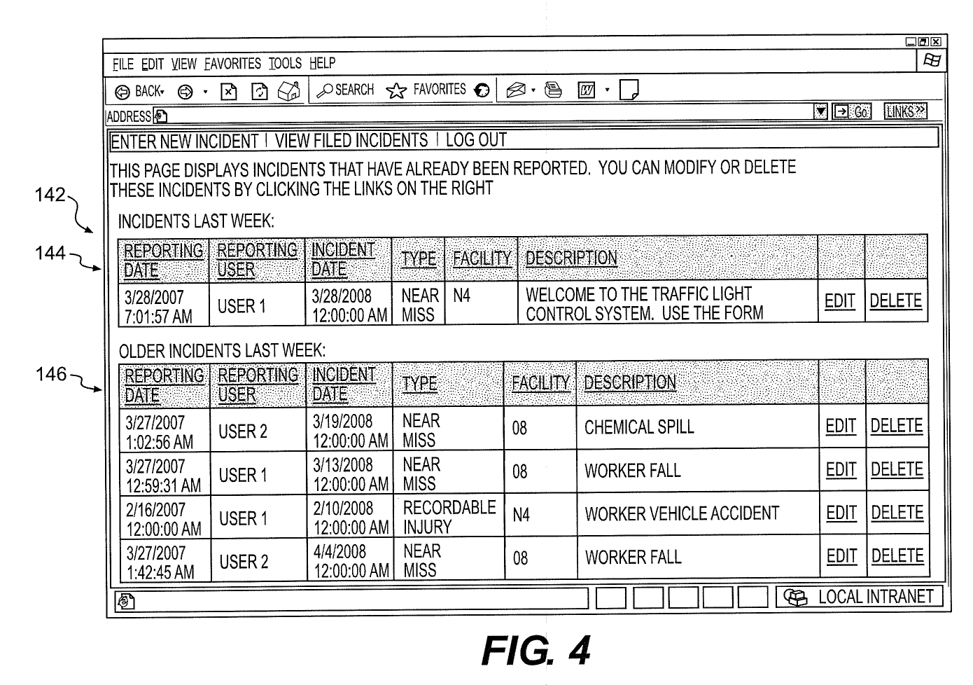

FIG. 4 illustrates an incident summary report interface 142. The incident summary report interface 142 displays incidents that occurred in the last week in the incidents in last week section 144 and older incidents in the older incidents section 146. The incident summary report interface 142 allows an operator to edit or delete information associated with each incident.

### INDUSTRIAL APPLICABILITY

The present disclosure is applicable to notification reporting. The disclosed system and methods may be useful in a workplace environment to show safety information. However, the disclosure is not limited to workplace environments.

In one embodiment, the disclosed system and methods are used to alert employees to the status of workplace incidents. Displaying workplace accident information reminds employees of the importance of safety. In some workplace environments, such as manufacturing facilities, dangerous conditions may exist. Displaying accident related information encourages employees to take proper safety precautions.

In one embodiment, multiple notification display systems 100 are distributed throughout a workplace facility. For example, in a manufacturing facility, notification display systems 100 can be placed at the entrances to the facility and a worker break room. In this way, employees are likely to see the systems. If the notification display systems 100 are configured to poll the centralized server 118 for notification data, the centralized server does not need to maintain a listing of network addresses for each notification display system 100. This allows the notification display systems 100 to be quickly added to the network or moved to new locations without having to make any configuration changes. In one embodiment, the notification display systems 100 use DHCP to obtain network addresses. Installation may occur without the need for configuring or reconfiguring the centralized server.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of providing a visual representation of notification data in a computing network, the computing network including at least one terminal and at least one centralized server, the method comprising the steps of:
inputting the notification data at a terminal in response to one or more prompts;
transmitting the notification data from the terminal to the at least one centralized server, the at least one centralized server storing the notification data;
installing at least one notification display system on the computing network by identifying the presence of the at least one notification display system to the at least one centralized server without reconfiguring the at least one centralized server;
polling the at least one centralized server by the at least one notification display system to obtain the notification data stored by the at least one centralized server;
displaying a visual indication of the notification data on the at least one notification display system.

2. The method of claim 1 wherein the visual indication is a coarse indication and wherein the method further comprises the step of displaying detailed notification data in addition to the coarse indication on the at least one notification display system.

3. The method of claim 2 wherein the detailed notification data includes the time since an alert.

4. The method of claim 3 wherein the alert includes accident notification data.

5. The method of claim 1 further comprising the step of storing the notification data on the at least one notification display system.

6. The method of claim 5 wherein the at least one notification display system comprises a computing device, a first display system for displaying a coarse indication and a second display system for displaying detailed notification data.

7. The method of claim 6 wherein the first display system is a stacklight.

8. The method of claim 6 wherein the second display system is a liquid crystal display.

9. The method of claim 1 further comprising presenting a video containing information related to the notification data.

10. A computer-readable medium having computer-executable instructions for providing notification data in a system having a data terminal and a centralized server
the computer-executable instructions comprising:
instructions for configuring at least one notification display system without manually configuring the centralized server;
instructions for polling the centralized server by the at least one notification display system to obtain the notification data stored by the centralized server;
instructions for displaying a visual indication of the notification data on the at least one notification display system.

11. The computer-readable medium according to claim 10 further comprising instructions for showing detailed notification data on the at least one notification display system.

12. The computer-readable medium according to claim 11 wherein the detailed notification data includes the time since an alert.

13. The computer-readable medium according to claim 12 wherein the alert includes accident notification data.

14. The computer-readable medium according to claim 10 further comprising instructions for storing the notification data on the at least one notification display system.

15. The computer-readable medium according to claim 14 wherein the at least one notification display system comprises a computing device, a first display system and a second display system.

16. The computer-readable medium according to claim 15 wherein the first display system is a stacklight.

17. The computer-readable medium according to claim 15 wherein the second display system is a liquid crystal display.

18. The computer-readable medium according to claim 10 further comprising presenting a video containing information related to the notification data.

19. A notification broadcasting system for distributing notification data to distinct locations within a network, the notification broadcasting system comprising:
at least one terminal capable of accepting the notification data from a user and transmitting the notification data to a server connected to the network;
at least two notification display systems connected to the network and capable of polling the server to obtain the notification data;
each of the at least two notification display systems comprising a first display system and a second display system; and
each of the at least two notification display systems displaying summary notification data on the first display system and detailed notification data on the second display system in response to the notification data being transmitted to the at least two notification display systems after the at least two notification display systems polls the server.

20. The notification broadcasting system of claim 19 wherein the first display system is a stacklight and the second display system is a liquid crystal display.
